(19) United States
(12) Patent Application Publication
(10) Pub. No.: US 2014/0157891 A1
(43) Pub. Date: Jun. 12, 2014

(54) FEED HOPPER LEVEL INDICATOR

(71) Applicant: Benjamin Columbus Price, Scotland Neck, NC (US)

(72) Inventor: Benjamin Columbus Price, Scotland Neck, NC (US)

(21) Appl. No.: 13/711,115

(22) Filed: Dec. 11, 2012

(51) Int. Cl. G01F 23/42

(52) U.S. Cl. CPC G01F 23/42
USPC 73/305

(57) ABSTRACT

The present invention relates to a device to measure the level of grain in an opaque grain hopper by using a float positioned on a vertical rod with a cord connected to an indicator weight positioned on the outside of the grain hopper.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for measuring the level of grain remaining in a grain hopper. In particular, the level of grain in a grain hopper can be measured on the inside of the hopper and viewed on the outside at a distance.

2. Description of Related Art

The owners of cattle and other livestock usually utilize large amounts of feed and grain at their location to feed and otherwise care for the animals. Feed grain bins tend to be made of metals and are opaque, creating a clear view from the outside of the contents remaining in the bin. Bin owners still primarily inventory their feed in a bin by climbing up and looking inside. Obviously this is time consuming as well as dangerous. Other owners use the acoustic method of throwing rocks against the side of the bin and noting the change in sound as an indicator of feed level. This is time consuming and not always that accurate.

Some devices have been developed to allow view from the outside. In one device in U.S. Pat. No. 4,385,672 to Schepel, there is a frame assembly lowered into the bin. The frame measures the depth, however, depending on how the frame is positioned, it can end up in a position which inaccurately measures the grain since there is nothing to keep the frame traveling downward as the grain shifts and moves during use of the bin. In addition it must be hung such that the center of the frame is in the center of the bin which requires additional rigging which can get tangled or experience problems. Accordingly, since the frame is expensive and has to be adapted to each size of bin, it does not appear to be in commercial use.

There needs to be a device for marking the contents of the inside of a grain bin and viewable from the outside that overcomes the limitations of the prior devices and methods of indicating grain level in a grain bin.

### BRIEF SUMMARY OF THE INVENTION

The present invention relates to the discovery that if a float is placed on a rod in a grain bin having opaque walls, it can be attached to a weight outside the bin to give a visual of the height of grain in the bin.

Accordingly in one embodiment the invention relates to an assembly for determining the height of the top of granular goods inside a container having one or more opaque walls comprising:
a) a vertically disposed rod positioned inside the container, the rod having and top and bottom running from about an inside top to about the inside bottom area of the container;
b) a float positioned on the rod that is free to move the length of the rod based on resting on the top of the granular goods; and
c) a cord connected to the float and running up the inside of the container to an opening in the opaque wall to a position outside the container where it is attached to an indicator weight such that the indicator weight moves up as the float moves down the rod as granular goods are removed from the container.

### BRIEF DESCRIPTION OF THE DRAWINGS

FIG. 1 is a cut through view of a feed container with the assembly of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawing featured in the figures is for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “granular goods” relates to items, like fungible goods which are generally stored in storage bins. Examples are feed grains but any solid granular media that is contained in a container with opaque sides is contemplated, therefore, anything from marbles, to nuts and bolts, or the like could benefit from the present invention. The granular goods will have a top level “height” of the goods which indicates how much is in the container and which top lowers as the amount of granular goods reduces in the container.

As used herein the term “container” refers to any type of container having one or more opaque walls designed for containing the granular goods. In the case of feed grain a grain storage bin would be the container. For purposes of the drawings a feed grain bin is shown but any container is contemplated with the granular goods.

As used herein the term “vertically disposed rod” refers to a stick, wand, staff, or the like, of wood, metal, or other material which is positioned inside the container at or close to perpendicular to ground having a top and bottom and positioned running from an inside top around where the highest level of granular material will be to the inside bottom area where the lowest level of granular material will be measured.

The rod can be positioned by any means and one viewing the disclosure herein will understand ways of mounting the rod, however, in one embodiment the rod position is mounted in an adjustable manner, for example, by running through a hole in a stud which can be tightened and the rod moved up or down. The rod can also have a stop at the bottom of the rod, for example, a bend in the rod or other enlargement to prevent any item on the rod from falling off the bottom by gravity.

As used herein the term “float” refers to an object that is positioned on the rod in a manner to freely move up and down on the rod. It can do this, for example, by having a hole in the float wherein the rod is threaded through the hole (as shown in the figures) though the hole can be anywhere in the float. Also a loop on the float, a runner guide or the like could be used. The idea is the float is light enough to rest on the top of the granular material and not sink substantially therein. As the level of the granular material lowers the float remains on top of the material guided by the rod. The rod keeps the float from moving around on the granular material and not rolling to some corner of the container. The float then is an indicator of the top level of the granular material. However, the float is on the inside of the container where it cannot be seen.

As used herein the term “cord” refers to a string or thin rope made of several strands braided, twisted, or woven together or solid material and made of natural synthetic metal or the like. The cord is attached to the float. The cord can be one or more guides on the inside or outside of the container to keep the cord from being tangled and to aid the cord in movement in and out of the container. In addition since there is a hole in the side of the container for the cord to exit, a rain shield or other protective device can be used to keep water from entering the container where the cord is threaded through the container.

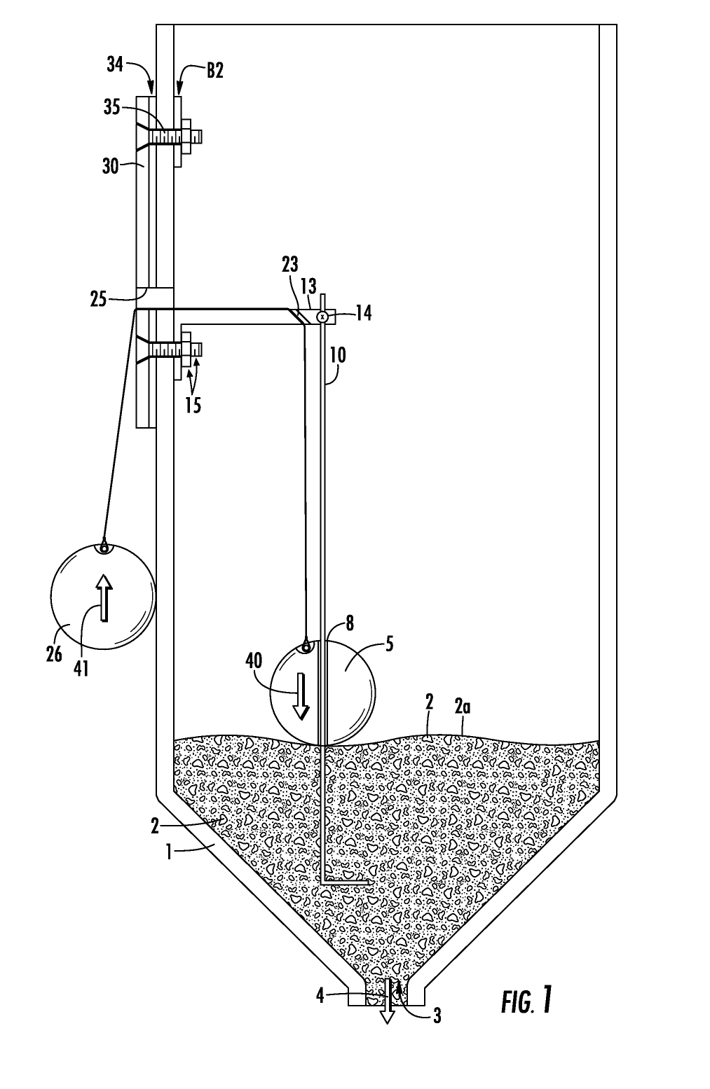

Now referring to the drawing, FIG. 1 depicts a cut through side view of an embodiment of the present invention in a container. In this view grain container 1 contains grain 2 having top level 2a. Grain 2 is removed from container 1 through bottom opening 3 in direction 4. Float 5 rests on grain top level 2a. A hole 8 runs through float 5 enabling rod 10 to be threaded through hole 8. Stop 11 prevents float 5 from coming off of rod 10. As the top level 2a lowers due to grain 2 being removed from the container 1 through the bottom opening 3, the float 5 continues to rest on top 2a and prevented from tolling around by its threaded condition through hole 8. Float always then indicates the level of the grain 2 in container 1. The rod 10 in this embodiment is attached to bracket 13 with bolt 14 which can be tightened and loosened to raise and lower the position of rod 10. The bracket 13 is attached to the inside of container 1 via nut and bolt 15. A cord 20 is attached to float 5 and runs up inside container 1 through cord guide 23, through the hole in container wall 25 to an area outside container 1. It is attached to indicator weight 26. A rain cover 30 is attached to the container 1 over hole 25 to help prevent rain water from entering hole 25 and getting grain 2 wet. Rain cover 30 is bolted to the container and there is a gasket 34 used as a mounting aide Bolt 15 and bolt 35 hold rain cover 30 on the container 1.

As can clearly be seen as grain level 2a goes down float 5 goes in direction 40 while indicator weight 26 goes in direction 41 and is an indicator of how much grain is in the container.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. An assembly for determining the height of the top of granular goods inside a container having one or more opaque walls comprising:
a) a vertically disposed rod positioned inside the container, the rod having and top and bottom running from about an inside top to about the inside bottom area of the container;
b) a float positioned on the rod that is free to move the length of the rod based on resting on the top of the granular goods; and
c) a cord connected to the float and running up the inside of the container to an opening in the opaque wall to a position outside the container where it is attached to an indicator weight such that the indicator weight moves up as the float moves down the rod as granular goods are removed from the container.

2. The assembly according to claim 1 where the float is position on the rod via a hole in the float.

3. The assembly according to claim 1 wherein there is a rain shield on the outside of the container positioned to keep precipitation from entering the opening in the opaque wall.

4. The assembly according to claim 1 wherein there are one or more cord guides on the inside of the container.

5. The assembly according to claim 1 wherein the rod has a stop for preventing the float from coming off the bottom of the rod.

6. The assembly according to claim 1 wherein the granular goods are granular feed.

7. The assembly according to claim 1 wherein the position of the rod is vertically adjustable.
